(19) United States
(12) Patent Application Publication
(10) Pub. No.: US 2011/0050870 A1
(43) Pub. Date: Mar. 3, 2011

(54) ORGANIC EL DISPLAY DEVICE

(76) Inventor: Jun HANARI, Kanazawa-shi (JP)

(21) Appl. No.: 12/873,629

(22) Filed: Sep. 1, 2010

(30) Foreign Application Priority Data
Sep. 3, 2009 (JP) 2009-203897

(51) Int. Cl. H04N 13/04; G09G 3/30; G09G 5/10

(52) U.S. Cl. 348/56; 345/77; 345/690; 348/E13.075

(57) ABSTRACT

According to one embodiment, an organic EL display device includes an organic EL element, a pixel circuit configured to include an output switch which controls emission/non-emission of the organic EL element, and a luminance switching module configured to output to the output switch a first control signal which causes the organic EL element to emit light with a first total emission time per unit time, when a first display mode of displaying a two-dimensional image is selected, and to output to the output switch a second control signal which causes the organic EL element to emit light with a second total emission time, which is longer than the first total emission time, per unit time, when a second display mode of displaying a three-dimensional image is selected.

### CROSS-REFERENCE TO RELATED APPLICATIONS

This application is based upon and claims the benefit of priority from Japanese Patent Application No. 2009-203897, filed Sep. 3, 2009; the entire contents of which are incorporated herein by reference.

### FIELD

Embodiments described herein relate generally to an organic electroluminescence (EL) display device.

### BACKGROUND

In recent years, display devices using organic electroluminescence (EL) elements have vigorously been developed, which have features of self-emission, a high response speed, a wide viewing angle and a high contrast, and which can realize further reduction in thickness and weight. The organic EL element is configured to include a thin film which tends to easily degrade due to the influence of moisture.

For example, there is known an electronic device including display means on which a 2D (two-dimensional) image and a 3D (three-dimensional) image are selectively displayed by switching. This electronic device has a display function of forcibly effecting switching to 2D image display at a time of 3D image display.

### BRIEF DESCRIPTION OF THE DRAWINGS

FIG. 1 is an exemplary plan view which schematically shows the structure of an organic EL display device according to an embodiment, which adopts an active matrix driving method;

FIG. 2 is an exemplary system configuration diagram of the organic EL display device according to the embodiment, which is configured such that a first display mode of displaying a two-dimensional (2D) image and a second display mode of displaying a three-dimensional (3D) image can be switched;

FIG. 3 is an exemplary block diagram showing the structure of a control circuit according to the embodiment;

FIG. 4 is an exemplary timing chart for explaining a luminance switching method, according to the embodiment, for switching the first display mode and the second display mode by the control circuit shown in FIG. 3;

FIG. 5 is an exemplary timing chart for explaining another luminance switching method, according to the embodiment, for switching the first display and the second display mode by the control circuit shown in FIG. 3;

FIG. 6 is an exemplary circuit diagram showing a pixel circuit which is of a voltage write type, according to the embodiment;

FIG. 7 is an exemplary timing chart for explaining the basic operation in the pixel circuit shown in FIG. 6, according to the embodiment;

FIG. 8 is an exemplary view for explaining the relationship between a duty ratio and an emission luminance of an organic EL element, according to the embodiment;

FIG. 9 is an exemplary view for explaining the relationship between a duty ratio in a case where the first display mode is selected and a duty ratio in a case where the second display mode is selected, according to the embodiment;

FIG. 10 is an exemplary view for explaining the relationship between a driving voltage, which is supplied to the pixel circuit via a video signal line, and an emission luminance of the organic EL element, according to the embodiment;

FIG. 11 is an exemplary view for explaining a relationship between a gradation and a driving voltage, according to the embodiment;

FIG. 12 is an exemplary view showing the structure of the control circuit according to the embodiment;

FIG. 13 is an exemplary view for describing another relationship between the gradation and the driving voltage, according to the embodiment;

FIG. 14 is an exemplary circuit diagram showing a pixel circuit which is of a current write type, according to the embodiment;

FIG. 15 is an exemplary timing chart for explaining the basic operation in the pixel circuit shown in FIG. 14, according to the embodiment;

FIG. 16 is an exemplary view for explaining the relationship between a driving current, which is supplied to the pixel circuit via a video signal line, and an emission luminance of the organic EL element, according to the embodiment;

FIG. 17 is an exemplary view for explaining a relationship between the gradation and the driving current, according to the embodiment;

FIG. 18 is an exemplary view showing the structure of a control circuit according to the embodiment;

FIG. 19 is an exemplary plan view which schematically shows the structure of an organic EL display device according to the embodiment, which adopts an active matrix driving method; and

FIGS. 20A, 20B, 20C, 20D, and 20E are exemplary diagrams for explaining methods of controlling the luminance in cases of displaying a video signal of a two-dimensional image corresponding to a first operational frequency (60 Hz) and a video signal of a three-dimensional image corresponding to a second operational frequency (120 Hz).

### DETAILED DESCRIPTION

In general, according to one embodiment, there is provided an organic EL display device comprising: an organic EL element; a pixel circuit configured to include an output switch which controls emission/non-emission of the organic EL element; and a luminance switching module configured to output to the output switch a first control signal which causes the organic EL element to emit light with a first total emission time per unit time, when a first display mode of displaying a two-dimensional image is selected, and to output to the output switch a second control signal which causes the organic EL element to emit light with a second total emission time, which is longer than the first total emission time, per unit time, when a second display mode of displaying a three-dimensional image is selected.

### First Embodiment

An embodiment of the invention will now be described with reference to the accompanying drawings. The structural elements having the same or similar functions in the respective drawings are denoted by like reference numerals, and an overlapping description is omitted.

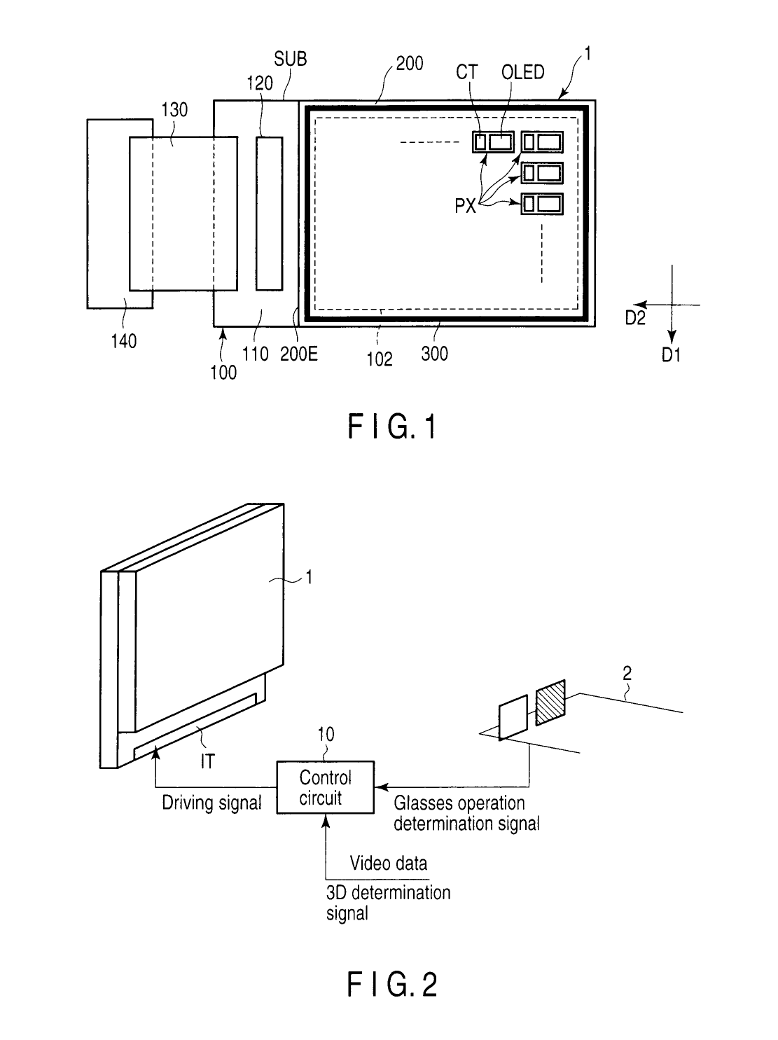

FIG. 1 is an exemplary plan view which schematically shows the structure of an organic EL display device according to an embodiment, which adopts an active matrix driving method.

The organic EL display device includes a display panel 1. The display panel 1 includes an array substrate 100 and a sealing substrate 200. The array substrate 100 includes a substantially rectangular active area 102 which displays an image. The active area 102 comprises an (m×n) number of pixels PX which are arranged in a matrix (m=a positive integer, n=a positive integer). Specifically, an m-number of pixels PX, which are arranged in a first direction D1, constitute one line of the active area 102. The active area 102 is composed of an n-number of lines which are arranged in a second direction D2.

The array substrate 100 includes an insulative substrate SUB such as a glass substrate, and organic EL elements OLED and pixel circuits CT, which are disposed in the respective pixels PX above the insulative substrate SUB. The organic EL element OLED may be constructed as a top emission type organic EL element which emits generated light from the sealing substrate 200 side, or a bottom emission type organic EL element which emits generated light from the array substrate 100 side.

The array substrate 100 includes an extension portion 110 which extends outward from an end portion 200E of the sealing substrate 200 on the outside of the active area 102. A driving IC 120 is mounted on the extension portion 110. The driving IC 120 supplies the pixel circuit CT with power and various control signals which are necessary for driving the organic EL element OLED. A flexible printed circuit board (hereinafter referred to as “FPC board”) 130 is connected to the extension portion 110. Further, a module board 140 is connected to the FPC board 130.

The sealing substrate 200 faces the organic EL elements OLED of the array substrate 100 in the active area 102. The sealing substrate 200 is an insulative substrate such as a glass substrate.

The array substrate 100 and the sealing substrate 200 are attached by a sealant 300 which is disposed in a frame shape in a manner to surround the active area 102. The sealant 300 is formed of a resin material or frit glass.

In the above-described organic EL display device, image data, which is successively transmitted, is accumulated for one line and then successively written in the pixels PX. Thereby, the organic EL elements OLED of the respective pixels PX are turned on, and an image for one frame is displayed during one frame period by the organic EL elements OLED of the active area 102.

FIG. 2 is an exemplary system structure configuration diagram of the organic EL display device according to the embodiment, which is configured such that a first display mode of displaying a two-dimensional (2D) image and a second display mode of displaying a three-dimensional (3D) image can be switched.

This example of the system configuration includes the display panel 1 having the above-described structure, glasses 2 which are provided with optical shutters on the right-eye side and left-eye side, and a control circuit 10. The display panel 1 and glasses 2 are connected to the control circuit 10. The control circuit 10 is supplied with video data of a 2D image or a 3D image, a 3D determination signal for determining that a 3D image is to be displayed, and a glasses operation determination signal for determining that the shutters of the glasses 2 have operated. The control circuit 10 outputs a driving signal, which is necessary for displaying a 2D image or a 3D image, to the display panel 1.

The control circuit 10 may be mounted on the display panel 1, or may be mounted on the above-described FPC board 130 or module board 140. Besides, the components constituting the control circuit 10 may be disposed in a distributed fashion on the display panel 1, FPC board 130 and module board 140. The display panel 1 includes, at least, an input terminal IT to which the driving signal, which is output from the control circuit 10, is input.

In the first display mode of displaying a 2D image, the display panel 1 displays an image during one frame period, based on the driving signal that is supplied from the control circuit 10. In the first display mode, the display panel 1 operates with a first operational frequency (e.g. 60 Hz).

In the second display mode of displaying a 3D image, the display panel 1 displays a right-eye image and a left-eye image by switching them during one frame period. Specifically, in the second display mode, each of the right-eye image and the left-eye image is switched with a second operational frequency (e.g. 120 Hz) which is double the first operational frequency.

In the second display mode, the right-eye and left-eye shutters of the glasses 2 are switched in sync with an image which is displayed on the display panel 1. Specifically, when a right-eye image is displayed on the display panel 1, the right-eye shutter of the glasses 2 is opened and the left-eye shutter is closed. On the other hand, when a left-eye image is displayed on the display panel 1, the left-eye shutter of the glasses 2 is opened and the right-eye shutter is closed. Thereby, the display of a 3D image corresponding to left-and-right parallax is realized.

When a 2D image is displayed, the 2D image that is displayed in one frame period can be observed by both eyes. When a 3D image is displayed, a right-eye image, which is displayed during about ½ of one frame period, is observed by the right eye, and a left-eye image, which is displayed during about ½ of one frame period, is observed by the left eye. Consequently, when the 3D image is displayed, it is felt that the displayed 3D image looks darker than in the case where the 2D image is displayed.

Thus, in the embodiment, the luminance of the organic EL element OLED in the case where the 3D image is displayed is set to be higher than the luminance of the organic EL element OLED in the case where the 2D image is displayed. Thereby, the difference in brightness of the displayed image, which is felt by the user when the 2D image and 3D image are switched, is decreased. An example of the concrete method therefor is described below.

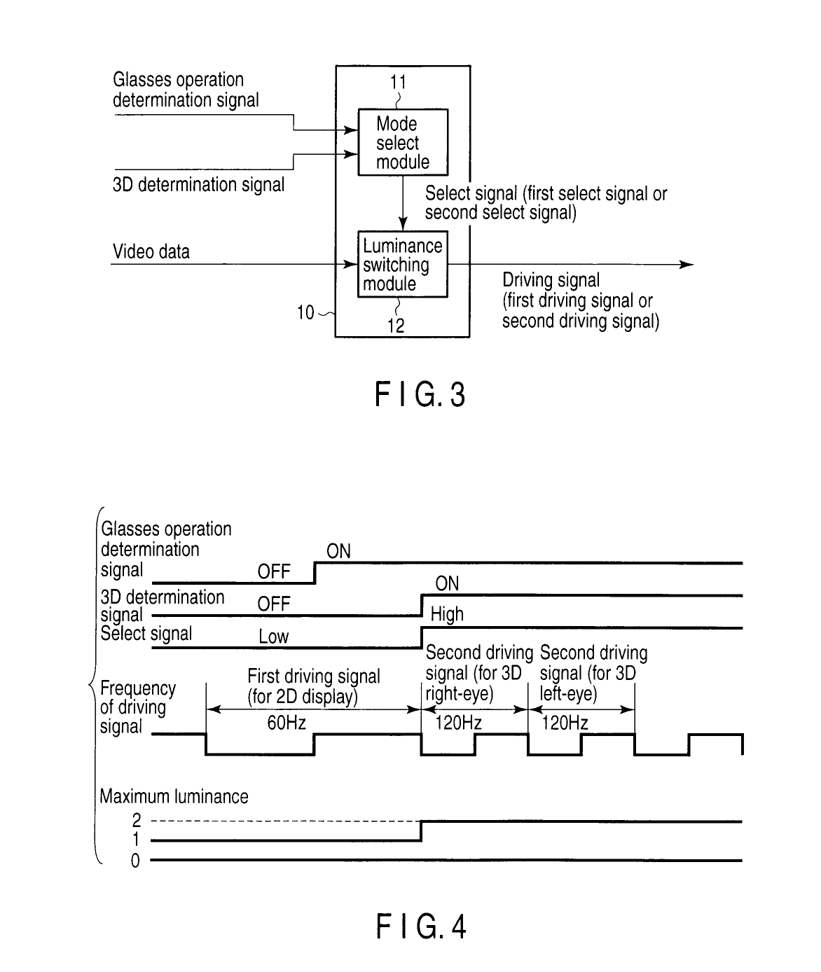

FIG. 3 an exemplary block diagram showing the structure of the control circuit according to the embodiment. The control circuit 10 includes a mode select module 11 and a luminance switching module 12.

When the above-described glasses operation determination signal from the glasses 2 or the 3D determination signal is in the OFF state, the mode select module 11 selects the first display mode of displaying the 2D image. In this case, the mode select module 11 may output a first select signal (e.g. “Low” level), which selects the first display mode, to the luminance switching module 12, or may not output a special select signal.

On the other hand, for example, when the glasses operation determination signal or the 3D determination signal, which is in the ON state, is received, the mode select module 11 selects the second display mode of displaying the 3D image. In this case, the mode select module 11 outputs a second select signal (e.g. “High” level), which selects the second display mode, to the luminance switching module 12.

The luminance switching module 12 outputs to the display panel 1 a driving signal corresponding to the selected display mode, based on the input video data. For example, when the first select signal is input from the mode select module 11 or when no select signal is input, the luminance switching module 12 outputs a first driving signal corresponding to the first display mode. On the other hand, when the second select signal is input from the mode select module 11, the luminance switching module 12 outputs a second driving signal corresponding to the second display mode. The first driving signal or second driving signal, which is output from the luminance switching module 12, is supplied to the input terminal IT of the display panel 1.

In the first display mode, the luminance switching module 12 outputs to the display panel 1 such a first driving signal that, for example, the emission luminance of the organic EL element OLED corresponding to each gray level of input video data may have a first gamma. On the other hand, in the second display mode, the luminance switching module 12 outputs to the display panel 1 such a second driving signal that, for example, the emission luminance of the organic EL element OLED corresponding to each gray level of input video data may have a second gamma which is greater than the first gamma. In short, the luminance range of the emission luminance of the organic EL element OLED in the second display mode is wider than the luminance range of the emission luminance of the organic EL element OLED in the first display mode.

Accordingly, in the first display mode, the luminance switching module 12 outputs the first driving signal which causes the organic EL element OLED to emit light with a first luminance (maximum luminance in the first display mode) in accordance with the maximum gray level. On the other hand, in the second display mode, the luminance switching module 12 outputs the second driving signal which causes the organic EL element OLED to emit light with a second luminance (maximum luminance in the second display mode), which is higher than the first luminance, in accordance with the maximum gray level. In the case where the second operational frequency in the second display mode is double the first operational frequency in the first display mode, it is desirable that the second luminance be double the first luminance.

FIG. 4 is an exemplary timing chart for explaining a luminance switching method, according to the embodiment, for switching the first display mode and the second display mode by the control circuit shown in FIG. 3.

In this example, when the first select signal of “Low” level is input from the mode select module 11 to the luminance switching module 12, the luminance switching module 12 outputs to the display panel 1 the first driving signal corresponding to the first operational frequency (60 Hz), based on the input video data of the 2D image. At this time, in the display panel 1, the organic EL element OLED emits light with a luminance in a relative luminance range between “0” and “1”, based on the first driving signal which is supplied from the luminance switching module 12. Specifically, the maximum luminance (first luminance) of the organic EL element OLED, which corresponds to the maximum gray level in the first display mode, is “1”.

The mode select module 11 outputs the second select signal of “High” level to the luminance switching module 12, when the glasses operation determination signal has been rendered “ON” and the 3D determination signal has been rendered “ON”. Based on the input of the second select signal, the luminance switching module 12 outputs, on the basis of the input video data of the 3D image, to the display panel 1 the second driving signal of the second operational frequency (120 Hz) corresponding to the second display mode, that is, the second driving signal including a driving signal for displaying a right-eye image and a driving signal for displaying a left-eye image. At this time, in the display panel 1, the organic EL element OLED emits light with a luminance in a relative luminance range between “0” and “2”, based on the second driving signal which is supplied from the luminance switching module 12. Specifically, the maximum luminance (second luminance) of the organic EL element OLED, which corresponds to the maximum gray level in the second display mode, is “2”, which corresponds to double the maximum luminance in the first display mode. As regards the emission luminance of the organic EL element OLED which corresponds to not only the maximum gray level but also each of gray levels, the emission luminance in the second display mode is double the emission luminance in the first display mode.

According to the above-described embodiment, each of the display period for displaying the right-eye image and the display period for displaying the left-eye image in one frame period in the second display mode is ½ of the display period for displaying the 2D image in one frame period in the first display mode. However, the emission luminance of the organic EL element OLED, which forms each of the right-eye image and left-eye image, is double the emission luminance of the organic EL element OLED at the time of forming the 2D image. Therefore, even if the display mode is switched between the first display mode of displaying the 2D image and the second display mode of displaying the 3D image, the variation in luminance of displayed images is reduced, and the 2D image and 3D image with good display quality can be displayed.

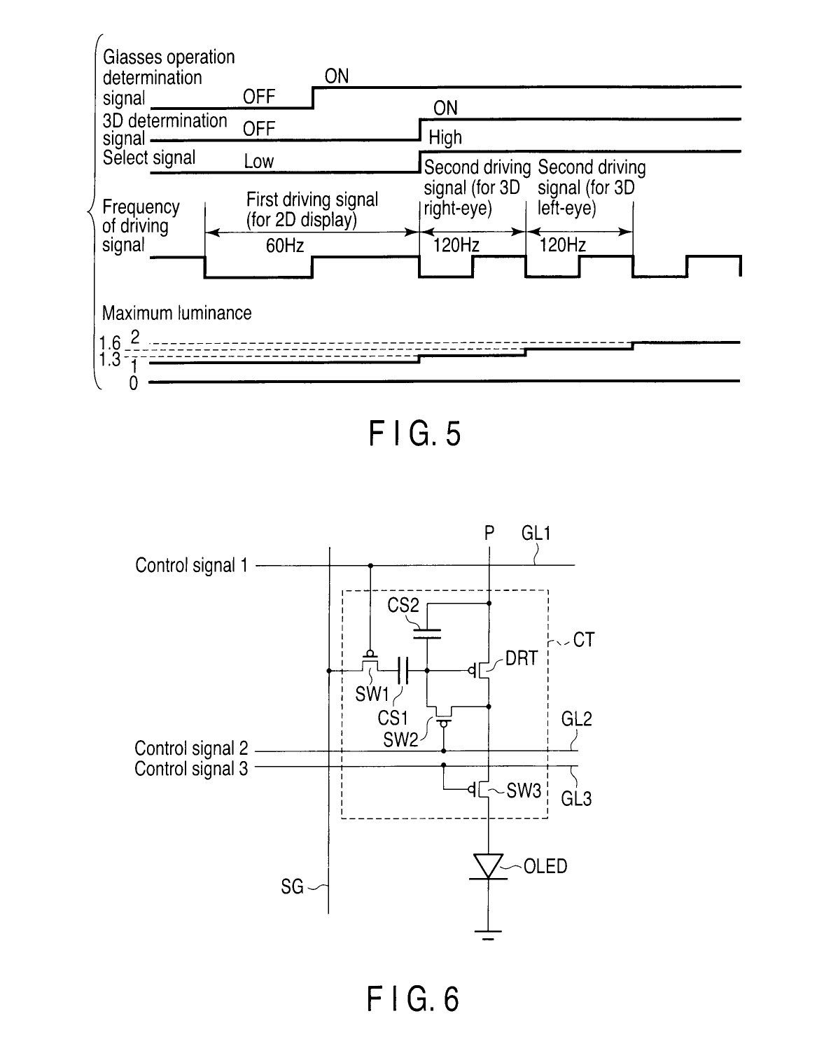

FIG. 5 is an exemplary timing chart for explaining another luminance switching method, according to the embodiment, for switching the first display and the second display mode by the control circuit shown in FIG. 3. In this example of the luminance switching method, when the first display mode of displaying the 2D image is switched to the second display mode of displaying the 3D image, the luminance is varied stepwise.

In the display panel 1, the organic EL element OLED emits light with a luminance in a relative luminance range between “0” and “1”, based on the output of the first driving signal corresponding to the first display mode from the luminance switching module 12. Specifically, the maximum luminance of the organic EL element OLED, which corresponds to the maximum gray level in the first display mode, is “1”.

At a timing immediately after the switching from the first display mode to the second display mode, the luminance switching module 12 sets the maximum luminance of the organic EL element OLED at a level higher than “1” and lower than “2”. In the meantime, the maximum luminance may be varied in a plurality of steps, until the maximum luminance of the organic EL element OLED is set at “2”.

In the example shown in FIG. 5, while the maximum luminance varies from “1” to “2”, the maximum luminance varies in two steps. At first, the maximum luminance of the organic EL element OLED is set at “1.3”. In other words, the organic EL element OLED emits light with a luminance in a relative luminance range between “0” and “1.3”. At a subsequent timing, the maximum luminance of the organic EL element OLED is set at “1.6”. In other words, the organic EL element OLED emits light with a luminance in a relative luminance range between “0” and “1.6”. In the example shown in FIG. 5, although the hold time of each step is not indicated, each step may be varied with a time of about 0.2 to 1.0 sec. In addition, the number of steps may be increased so that the maximum luminance may be gradually varied.

In the above-described example, when the maximum luminance in the first display mode is set at “1”, the maximum luminance in the second display mode is “2”. However, the setting of the maximum luminance is not limited to this example. The maximum luminance in the second display mode may be selected in a range of about 1.5 times to 2.5 times the maximum luminance in the first display mode, and it is desirable that the maximum luminance be adjusted such that the decrease in display quality of the 3D image due to the decrease in luminance may be tolerable.

If the switching of the display mode occurs frequently, there may occur such a case that an unpleasant feeling is given to the user. Taking this into account, it is effective to provide a so-called hysteresis which keeps a state for a predetermined time. In the examples of FIG. 4 and FIG. 5, the select signal for switching the first display mode to the second display mode is output at the same time as the two determination signals, namely, the glasses operation determination signal and 3D determination signal, have been rendered “ON”. However, in an alternative setting, for example, with a hold period of about 1 sec after the two determination signals are rendered “ON”, the first display mode may be switched to the second display mode. Similarly, in another alternative setting, if the “OFF” state of the two determination signals remains unchanged for a predetermined time period, the second display mode may be switched to the first display mode.

The above-described glasses operation determination signal for determining that the shutters of the glasses 2 have operated may be configured to interlock with an operation switch (not shown) of the glasses 2, or may be output on the basis of a detection signal from a detection device which is provided on a temple or a bridge of the glasses 2 to determine the state in which the glasses 2 are worn. It is desirable that the glasses operation determination signal be produced as a signal reflecting the actual state of use of the glasses 2.

In the above-described luminance switching method, it is possible to apply a method of switching the total emission time per unit time of the organic EL element OLED (in this example, the total emission time corresponds to the ratio (T2/T1) of an emission time T2 of light emission of the organic EL element OLED to a display time T1, and this total emission time is referred to as “duty ratio”) between the first display mode and the second display mode, or to apply a method of switching a video signal necessary for driving the organic EL element OLED (a driving voltage in the case where the pixel circuit CT is of a voltage write type, or a driving current in the case where the pixel circuit CT is of a current write type) between the first display mode and the second display mode.

Next, a description is given of a more concrete luminance switching method in the case where the pixel circuit CT of the voltage write type is applied.

FIG. 6 is an exemplary circuit diagram showing the pixel circuit which is of the voltage write type, according to the embodiment.

The pixel circuit CT comprises a driving transistor DRT which controls the driving of the organic EL element OLED, three switches SW1, SW2 and SW3, and two storage capacitance elements CS1 and CS2. The three switches SW1, SW2 and SW3 and the driving transistor DRT are composed of p-channel thin-film transistors.

The gate electrode of the switch SW1 is connected to a first gate line GL1, and the source electrode thereof is connected to a video signal line SG. A control signal 1, which controls ON/OFF of the switch SW1, is supplied to the first gate line GL1. A video signal is supplied to the video signal line SG. The gate electrode of the driving transistor DRT is connected to the drain electrode of the switch SW1 via the storage capacitance element CS1. The source electrode of the driving transistor DRT is connected to a power line P, and the drain electrode thereof is connected to the switch SW3. The storage capacitance element CS2 is formed between the gate electrode and source electrode of the driving transistor DRT.

The switch SW2 is connected between the gate electrode and drain electrode of the driving transistor DRT, and the gate electrode of the switch SW2 is connected to a second gate line GL2. A control signal 2, which controls ON/OFF of the switch SW2, is supplied to the second gate line GL2. The gate electrode of the switch SW3 is connected to a third gate line GL3. A control signal 3, which controls ON/OFF of the switch SW3, is supplied to the third gate line GL3. The source electrode of the switch SW3 is connected to the driving transistor DRT, and the drain electrode thereof is connected to the organic EL element OLED. The switch SW3 corresponds to an output switch which controls emission/non-emission of the organic EL element OLED.

Next, a description is given of a luminance switching method of switching the duty ratio between the first display mode and the second display mode, as a luminance switching method which is applicable to the above-described pixel circuit CT.

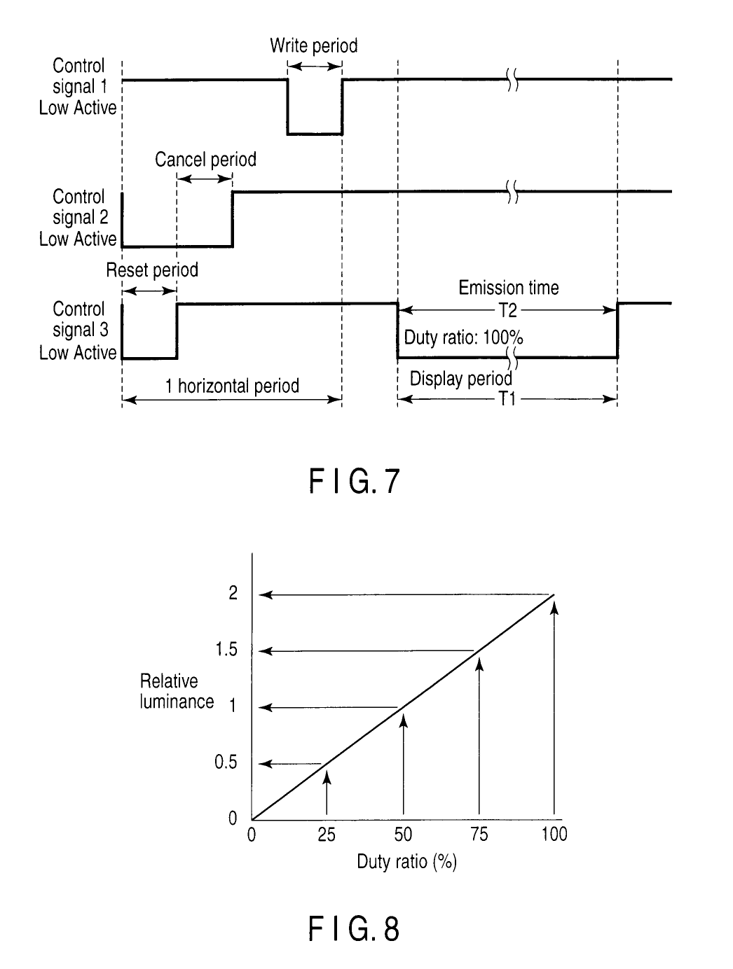

FIG. 7 is an exemplary timing chart for explaining the basic operation in the pixel circuit shown in FIG. 6, according to the embodiment. One horizontal period includes a reset period, a cancel period which follows the reset period, and a write period which comes after the cancel period.

The reset period corresponds to a period in which the control signal 1 supplied to the first gate line GL1 is “OFF”, the control signal 2 supplied to the second gate line GL2 is “ON” and the control signal 3 supplied to the third gate line GL3 is “ON” (i.e. the period in which the switch SW1 is “OFF” and the switch SW2 and switch SW3 are “ON”).

The cancel period corresponds to a period in which the control signal 1 is “OFF”, the control signal 3 is “OFF” and the control signal 2 is “ON” (i.e. the period in which the switch SW1 and switch SW3 are “OFF” and the switch SW2 is “ON”). The write period corresponds to a period in which the control signal 2 and control signal 3 are “OFF” and the control signal 1 is “ON” (i.e. the period in which the switch SW2 and switch SW3 are “OFF” and the switch SW1 is “ON”), and in this write period a video signal is written in the pixel circuit CT. Subsequently, the control signal 1, control signal 2 and control signal 3 are rendered “OFF”, and the video signal written in the pixel circuit CT is retained for a predetermined time period.

Thereafter, in a period in which the control signal 1 and control signal 2 are “OFF” and the control signal 3 is rendered “ON”, electric current, which is controlled by the driving transistor DRT, is supplied to the organic EL element OLED, and the organic EL element OLED emits light with a predetermined luminance. In the example shown in FIG. 7, in the display period T1, the control signal 3 is constantly “ON” and the organic EL element OLED constantly emits light. In other words, the display period T1 is equal to the emission period T2 in which the organic EL element OLED emits light, and this corresponds to the case in which the duty ratio is 100%.

In this manner, the duty ratio can be controlled by the time (i.e. emission time T2) in which the control signal 3 is “ON” in the display period T1. Specifically, since the control signal 3 corresponds to the signal that controls the emission time T2, the effective luminance of the organic EL element OLED can be adjusted by adjusting the emission time T2 of the organic EL element OLED in the display period T1 by the ON/OFF of the control signal 3. The control signal 3 and the video signal, which is written in the pixel circuit CT, are output from the luminance switching module 12 to the display panel 1 as a driving signal corresponding to the display mode.

FIG. 8 is an exemplary view for explaining the relationship between the duty ratio and the emission luminance of the organic EL element, according to the embodiment. The abscissa in FIG. 8 indicates the duty ratio (%) and the ordinate indicates a relative luminance at a time when the emission luminance of the organic EL element OLED in the case where the duty ratio is 50% is set at 1. As shown in FIG. 8, the duty ratio and the luminance have a substantially proportional relationship. When the duty ratio is 100%, the relative luminance of the organic EL element OLED is 2. When the duty ratio is 25%, the relative luminance of the organic EL element OLED is 0.5. When the duty ratio is 75%, the relative luminance of the organic EL element OLED is 1.5.

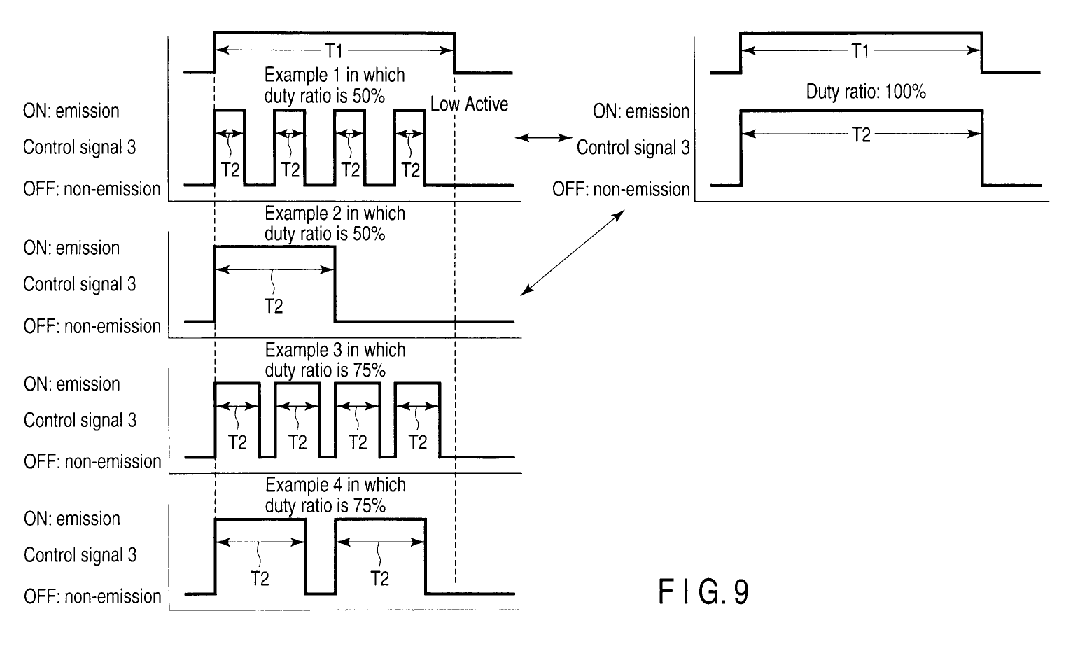

FIG. 9 is an exemplary view for explaining the relationship between the duty ratio in a case where the first display mode is selected and the duty ratio in a case where the second display mode is selected, according to the embodiment. In FIG. 9, it is assumed that the emission luminance of the organic EL element OLED in the case where the duty ratio is 50% is the emission luminance in the first display mode, and the emission luminance of the organic EL element OLED in the case where the duty ratio is 100% is the emission luminance in the second display mode.

When the first display mode is selected, the luminance switching module 12 outputs from the third gate line GL3 to the switch SW3 the control signal 3 (first control signal) which controls the emission/non-emission of the organic EL element OLED so that the total emission time, which is the total of the emission time T2 in which the organic EL element OLED emits light (i.e. the “ON” period of control signal 3), may become ½ of the display period T1, as shown in Example 1 or Example 2.

When the second display mode is selected, the luminance switching module 12 outputs the control signal 3 (second control signal), which is constantly “ON” in the display period T1, to the switch SW3 from the third gate line GL3.

In FIG. 9, Example 3 and Example 4 correspond to the case in which the duty ratio is 75%. Specifically, in the case of applying the luminance switching method which has been described with reference to FIG. 5, when the display mode is switched between the first display mode with the duty ratio of 50% and the second display mode with the duty ratio of 100%, the duty ratio is temporarily set at 75%. Thereby, the luminance can be varied stepwise.

Next, a description is given of a luminance switching method of switching a driving voltage, which is supplied to the video signal line SG as a video signal necessary for driving the organic EL element OLED, between the first display mode and the second display mode, as a luminance switching method which is applicable to the above-described pixel circuit CT.

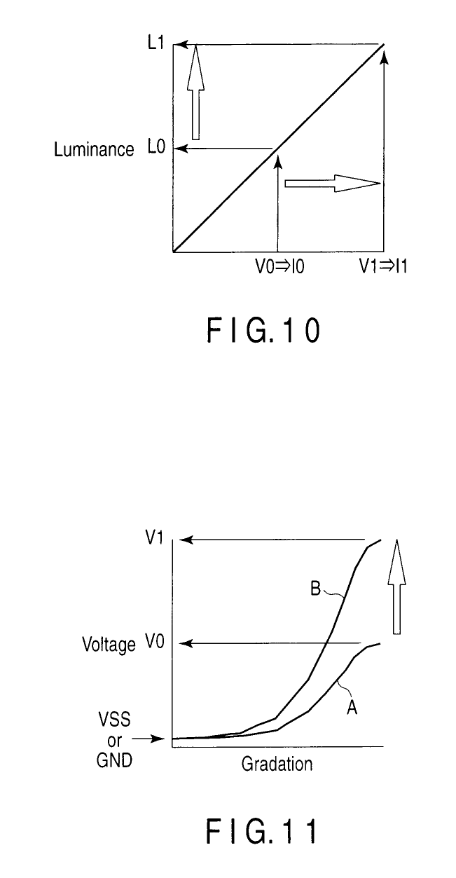

FIG. 10 is an exemplary view for explaining the relationship between the driving voltage, which is supplied to the pixel circuit via the video signal line, and the emission luminance of the organic EL element, according to the embodiment. In FIG. 10, the abscissa indicates the driving voltage, and the ordinate indicates the emission luminance of the organic EL element OLED. In the case where the pixel circuit CT is of the voltage write type, the pixel circuit CT executes voltage-current conversion, and, as a result, the driving voltage and emission luminance have a substantially proportional relationship.

When the driving voltage is V0, the emission luminance of the organic EL element OLED is L0. When the driving voltage is V1 (=2*V0), the emission luminance of the organic EL element OLED is L1 (=2*L0). In this case, for example, the emission luminance of the organic EL element OLED, which corresponds to the maximum gray level in the case where the first display mode is selected, is set at L0, and the emission luminance of the organic EL element OLED, which corresponds to the maximum gray level in the case where the second display mode is selected, is set at L1.

FIG. 11 is an exemplary view for explaining a relationship between a gradation and a driving voltage, according to the embodiment. In FIG. 11, the abscissa indicates the gradation, and the ordinate indicates the driving voltage. The driving voltage at the minimum gray level is a low-potential voltage VSS or a ground potential GND. FIG. 11 shows a first tone curve A having a gamma with which the driving voltage at the maximum gray level is V0, and a second tone curve B having a gamma with which the driving voltage at the maximum gray level is V1. In this case, the maximum gray level in the first tone curve A is equal to the maximum gray level in the second tone curve B.

When the first display mode is selected, use can be made of a first voltage range between the driving voltage VSS or GND at the minimum gray level and the driving voltage V0 at the maximum gray level. The driving voltage in the first voltage range is output to the driving transistor DRT in accordance with each of the gray levels. When the second display mode is selected, use can be made of a second voltage range between the driving voltage VSS or GND at the minimum gray level and the driving voltage V1 at the maximum gray level. The driving voltage in the second voltage range is output to the driving transistor DRT in accordance with each of the gray levels.

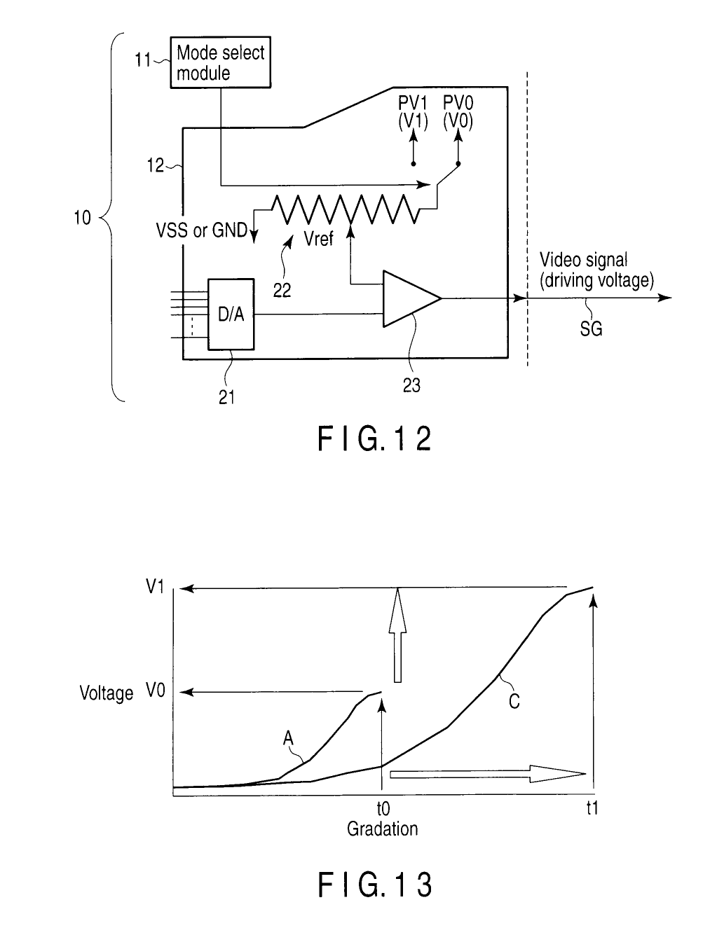

FIG. 12 is an exemplary view showing the structure of the control circuit according to the embodiment.

The control circuit 10, as described above, is configured to include the mode select module 11 and luminance switching module 12. The luminance switching module 12 comprises a D/A converter 21 which converts input digital-format video data to an analog-format voltage, a voltage division circuit 22, an amplifier 23, a first reference voltage source PV0 and a second reference voltage source PV1. The first reference voltage source PV0 supplies a first reference voltage V0 of a higher potential than the low-potential voltage VSS or ground potential GND. The second reference voltage source PV1 supplies a second reference voltage V1 of a higher potential than the first reference voltage V0. The voltage division circuit 22 divides a voltage between the low-potential voltage VSS or ground potential GND and the first reference voltage V0 or second reference voltage V1, which has a higher potential than the low-potential voltage VSS or ground potential GND.

When the first display mode is selected by the mode select module 11, this luminance switching module 12 selects the first reference voltage V0 as the driving voltage at the maximum gray level. Thereby, the first voltage range between the low-potential voltage VSS or ground potential GND and the first reference voltage V0 can be used, and the luminance switching module 12 outputs a driving voltage in the first voltage range, which corresponds to the gradation of video data, as a first video signal to the driving transistor DRT via the video signal line SG. When the driving voltage V0 corresponding to the maximum gray level is output to the driving transistor DRT, the organic EL element OLED emits light with the emission luminance L0.

When the second display mode is selected by the mode select module 11, the luminance switching module 12 selects the second reference voltage V1 as the driving voltage at the maximum gray level. Thereby, the second voltage range between the low-potential voltage VSS or ground potential GND and the second reference voltage V1 can be used, and the luminance switching module 12 outputs a driving voltage in the second voltage range, which corresponds to the gradation of video data, as a second video signal to the driving transistor DRT via the video signal line SG. When the driving voltage V1 corresponding to the maximum gray level is output to the driving transistor DRT, the organic EL element OLED emits light with the emission luminance L1. In this manner, by adjusting the maximum driving voltage, the compression and expansion of the dynamic range of the driving voltage are enabled.

In the case of applying the luminance switching method which has been described with reference to FIG. 5, when the display mode is switched between the first display mode in which the driving voltage corresponding to the maximum gray level is V0 and the second display mode in which the driving voltage corresponding to the maximum gray level is V1, the driving voltage corresponding to the maximum gray level is varied stepwise between V0 and V1.

FIG. 13 is an exemplary view for describing another relationship between the gradation and the driving voltage, according to the embodiment. In FIG. 13, the abscissa indicates the gradation, and the ordinate indicates the driving voltage. FIG. 13 shows a first tone curve A having a gamma with which the driving voltage at a maximum gray level t0 is V0, and a third tone curve C having a gamma with which the driving voltage at a maximum gray level t1, which is higher than t0, is V1 which is higher than V0. In the case where the maximum gray level t1 of the third tone curve C corresponds to double the maximum gray level t0 of the first tone curve A, the driving voltage V1 is almost double the driving voltage V0. If the steps of the gradation of the third tone curve C are equal to those of the gradation of the first tone curve A, the third tone curve C is identical to the second tone curve B shown in FIG. 11.

As indicated by the third tone curve C, by increasing the number of gray levels in accordance with the expansion of the dynamic range of the driving voltage, an image with a higher image quality can be displayed.

Next, a description is given of a more concrete luminance switching method in the case where the pixel circuit CT of the current write type is applied. An overlapping description with the above-described case of the voltage write type is omitted here.

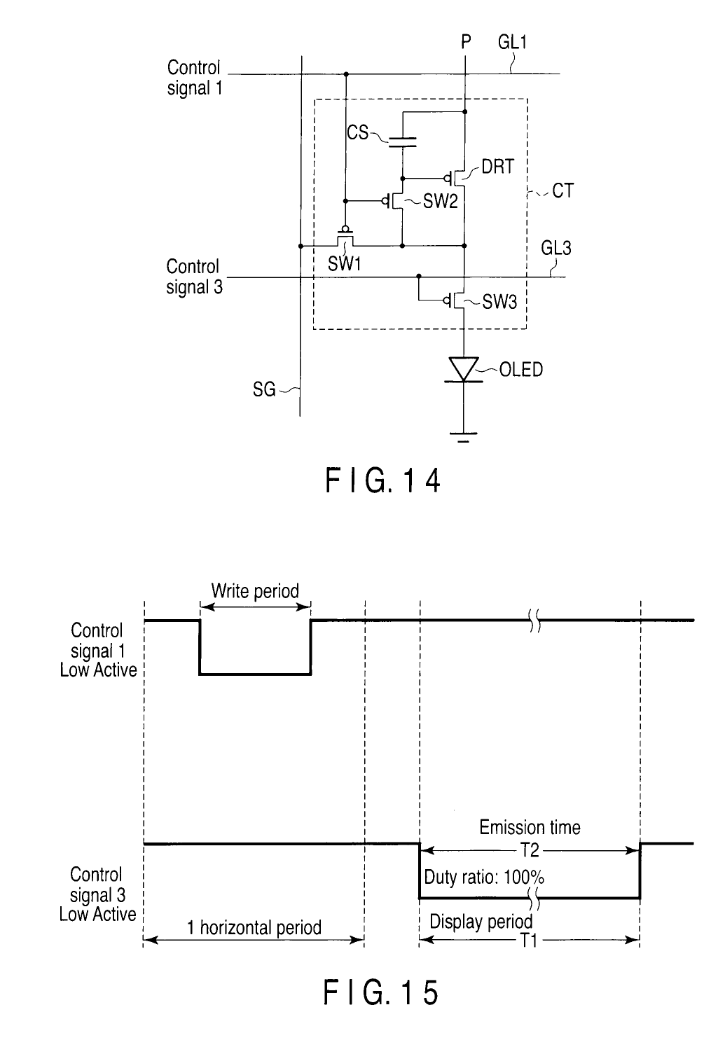

FIG. 14 is an exemplary circuit diagram showing the pixel circuit which is of the current write type, according to the embodiment.

The pixel circuit CT comprises a driving transistor DRT which controls the driving of the organic EL element OLED, three switches SW1, SW2 and SW3, and a storage capacitance element CS. The three switches SW1, SW2 and SW3 and the driving transistor DRT are composed of p-channel thin-film transistors.

The gate electrode of the switch SW1 is connected to a first gate line GL1, and the source electrode thereof is connected to a video signal line SG. A control signal 1, which controls ON/OFF of the switch SW1, is supplied to the first gate line GL1. A video signal is supplied to the video signal line SG. The source electrode of the driving transistor DRT is connected to a power line P, and the drain electrode thereof is connected to the switch SW3. The storage capacitance element CS is formed between the gate electrode and source electrode of the driving transistor DRT.

The switch SW2 is connected between the switch SW1 and the gate electrode of the driving transistor DRT. The gate electrode of the switch SW2 is connected to the first gate line GL1. The gate electrode of the switch SW3 is connected to a third gate line GL3. A control signal 3, which controls ON/OFF of the switch SW3, is supplied to the third gate line GL3. The source electrode of the switch SW3 is connected to the driving transistor DRT, and the drain electrode thereof is connected to the organic EL element OLED. The switch SW3 corresponds to an output switch which controls emission/non-emission of the organic EL element OLED.

Next, a description is given of a luminance switching method of switching the duty ratio between the first display mode and the second display mode, as a luminance switching method which is applicable to the above-described pixel circuit CT.

FIG. 15 is an exemplary timing chart for explaining the basic operation in the pixel circuit shown in FIG. 14, according to the embodiment. One horizontal period includes a write period. The write period corresponds to a period in which the control signal 3, which is supplied to the third gate line GL3, is “OFF” and the control signal 1, which is supplied to the first gate line GL1, is “ON” (i.e. the period in which the switch SW3 is “OFF” and the switch SW1 and switch SW2 are “ON”), and in this write period a video signal is written in the pixel circuit CT. Subsequently, the control signal 1 and control signal 3 are rendered “OFF”, and the video signal written in the pixel circuit CT is retained for a predetermined time period.

Thereafter, in a period in which the control signal 1 is “OFF” and the control signal 3 is rendered “ON”, electric current, which is controlled by the driving transistor DRT, is supplied to the organic EL element OLED, and the organic EL element OLED emits light with a predetermined luminance. In the example shown in FIG. 15, in the display period T1, the control signal 3 is constantly “ON” and the organic EL element OLED constantly emits light. In other words, the display period T1 is equal to the emission period T2 in which the organic EL element OLED emits light, and this corresponds to the case in which the duty ratio is 100%.

As has been described above, the duty ratio and the emission luminance of the organic EL element OLED have a substantially proportional relationship. Thus, the same luminance switching as in the case of the voltage driving method can be performed by using such setting that the emission luminance of the organic EL element OLED in the case where the duty ratio is 50% is the emission luminance in the first display mode, and the emission luminance of the organic EL element OLED in the case where the duty ratio is 100% is the emission luminance in the second display mode.

Next, a description is given of a luminance switching method of switching a driving current, which is supplied to the video signal line SG as a video signal necessary for driving the organic EL element OLED, between the first display mode and the second display mode, as a luminance switching method which is applicable to the above-described pixel circuit CT.

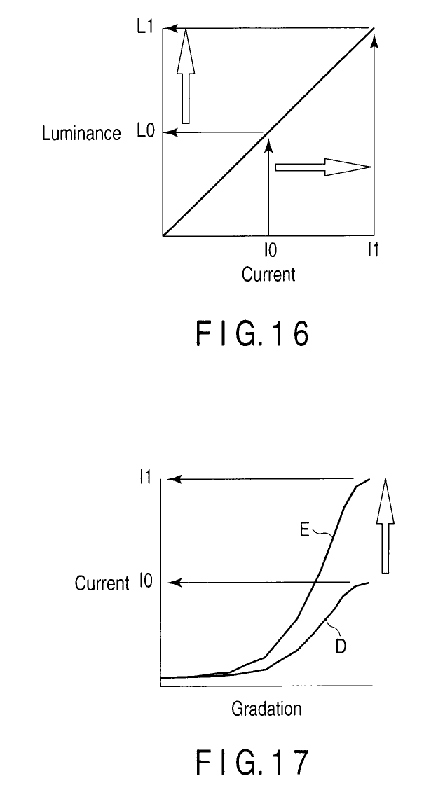

FIG. 16 is an exemplary view for explaining the relationship between the driving current, which is supplied to the pixel circuit via the video signal line, and the emission luminance of the organic EL element, according to the embodiment. In FIG. 16, the abscissa indicates the driving current, and the ordinate indicates the emission luminance of the organic EL element OLED. In the case where the pixel circuit CT is of the current write type, the driving current and emission luminance have a substantially proportional relationship.

When the driving current is I0, the emission luminance of the organic EL element OLED is L0. When the driving current is I1 (=2*I0), the emission luminance of the organic EL element OLED is L1 (=2*L0). In this case, for example, the emission luminance of the organic EL element OLED, which corresponds to the maximum gray level in the case where the first display mode is selected, is set at L0, and the emission luminance of the organic EL element OLED, which corresponds to the maximum gray level in the case where the second display mode is selected, is set at L1.

FIG. 17 is an exemplary view for explaining the relationship between the gradation and the driving current, according to the embodiment. In FIG. 17, the abscissa indicates the gradation, and the ordinate indicates the driving current. FIG. 17 shows a fourth tone curve D having a gamma with which the driving current at the maximum gray level is I0, and a fifth tone curve E having a gamma with which the driving current at the maximum gray level is I1. In this case, the maximum gray level in the fourth tone curve D is equal to the maximum gray level in the fifth tone curve E.

When the first display mode is selected, use can be made of a first current range of up to the driving current I0 at the maximum gray level, and the driving current in the first current range is output to the driving transistor DRT in accordance with each of the gray levels. When the second display mode is selected, use can be made of a second current range of up to the driving current I1 at the maximum gray level, and the driving current in the second current range is output to the driving transistor DRT in accordance with each of the gray levels.

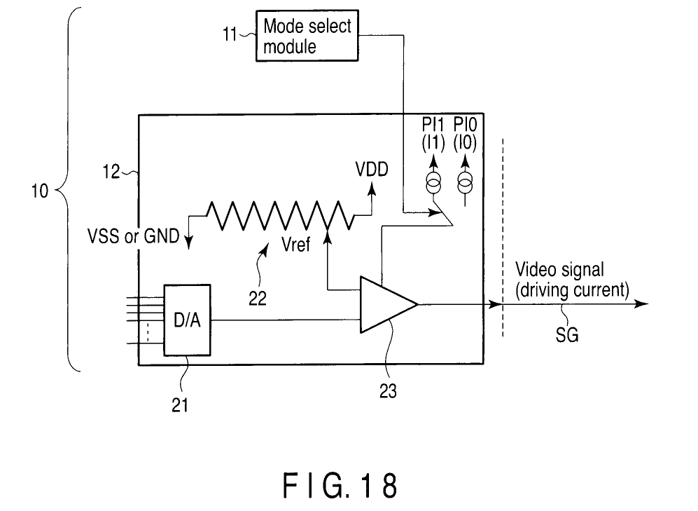

FIG. 18 is an exemplary view showing the structure of the control circuit according to the embodiment.

The control circuit 10, as described above, is configured to include the mode select module 11 and luminance switching module 12. The luminance switching module 12 comprises a D/A converter 21 which converts input digital-format video data to an analog-format voltage, a voltage division circuit 22, an amplifier 23, a first reference current source PI0 and a second reference current source PI1. The first reference current source PI0 supplies a first reference current I0. The second reference current source PI1 supplies a second reference current I1 which is higher than the first reference current I0. The voltage division circuit 22 divides a voltage in a range between the low-potential voltage VSS or ground potential GND and a high-potential voltage VDD.

When the first display mode is selected by the mode select module 11, this luminance switching module 12 selects the first reference current source PI0. Thereby, the first current range of up to the maximum current I0 of the first reference current source PI0 can be used, and the luminance switching module 12 outputs a driving current in the first current range, which corresponds to the gradation of video data, as a first video signal to the driving transistor DRT via the video signal line SG. When the driving current I0 corresponding to the maximum gray level is output to the driving transistor DRT, the organic EL element OLED emits light with the emission luminance L0.

When the second display mode is selected by the mode select module 11, the luminance switching module 12 selects the second reference current source PI1. Thereby, the second current range of up to the maximum current I1 of the second reference current source PI1 can be used, and the luminance switching module 12 outputs a driving current in the second current range, which corresponds to the gradation of video data, as a second video signal to the driving transistor DRT via the video signal line SG. When the driving current I1 corresponding to the maximum gray level is output to the driving transistor DRT, the organic EL element OLED emits light with the emission luminance L1. In this manner, by adjusting the maximum driving current, the compression and expansion of the dynamic range of the driving current are enabled.

In the case of applying the luminance switching method which has been described with reference to FIG. 5, when the display mode is switched between the first display mode in which the driving current corresponding to the maximum gray level is I0 and the second display mode in which the driving current corresponding to the maximum gray level is I1, the driving current corresponding to the maximum gray level is varied stepwise between I0 and I1. Thereby, a sharp variation in luminance can be relaxed.

As has been described with reference to FIG. 13, the number of gray levels may be increased in accordance with the expansion of the dynamic range of the driving current.

### Second Embodiment

In a second embodiment, the structure of the display panel of the organic EL display device is disclosed in greater detail, and the duty ratio is switched by a luminance switching method which is different from the luminance switching method which has been described in the first embodiment. The same parts as in the first embodiment are denoted by like reference numerals, and a detailed description thereof is omitted here.

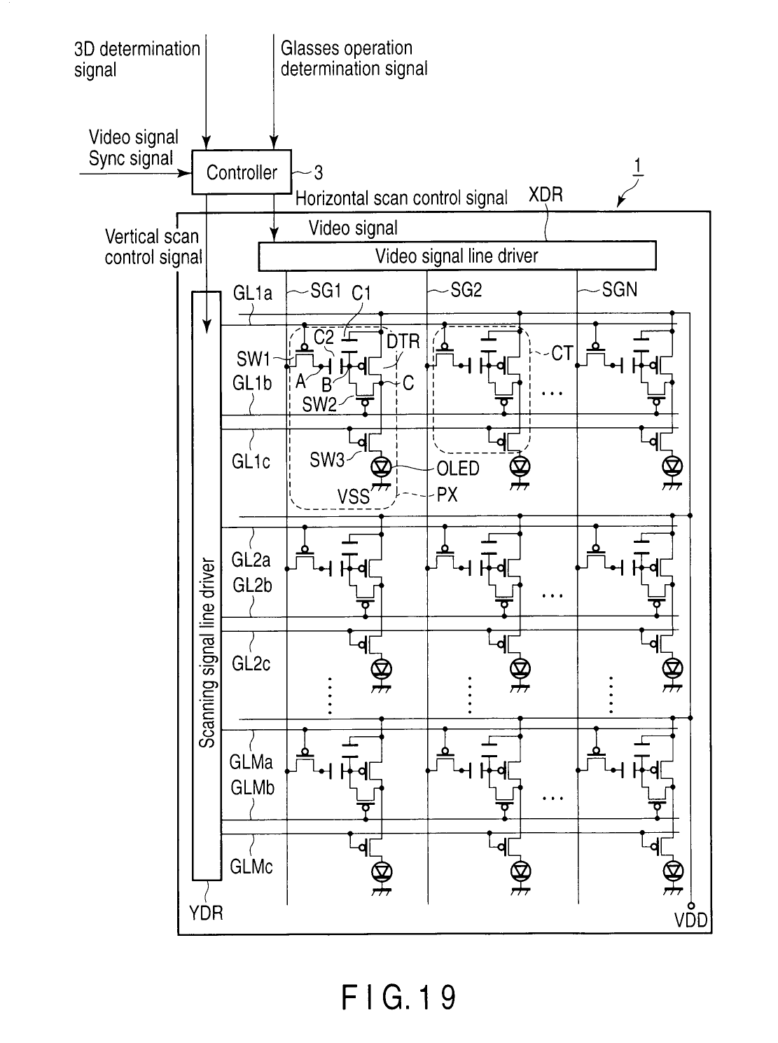

FIG. 19 is an exemplary plan view which schematically shows the structure of an organic EL display device according to the embodiment, which adopts an active matrix driving method.

The organic EL display device comprises a display panel 1 and a controller 3 which controls the display operation of the display panel 1.

The display panel 1 comprises a plurality of pixels PX, a plurality of scanning signal lines GL1a to GLMa, GL1b to GLMb, and GL1c to GLMc, a plurality of video signal lines SG1 to SGN, a scanning signal line driver YDR, and a video signal line driver XDR.

The pixels PX are arranged in a matrix of M×N on a light-transmissive, insulative support substrate such as a glass plate. Each pixel PX includes an organic EL element OLED which is a self-luminous element, and includes a pixel circuit CT. The pixel circuit CT shown in FIG. 19 is a pixel circuit of a voltage write type. Since the details of the operation of the pixel circuit CT have already been described, an overlapping description is omitted here.

The scanning signal lines GL1a to GLMa, GL1b to GLMb, and GL1c to GLMc extend along the rows of the pixels PX. The video signal lines SG1 to SGN extend in a direction substantially perpendicular to the rows of the pixels PX. The scanning signal line driver YDR sequentially drives the scanning signal lines GL1a to GLMa, GL1b to GLMb, and GL1c to GLMc. The video signal line driver XDR drives the video signal lines SG1 to SGN.

The controller 3 is formed on a printed board which is disposed outside the display panel 1, and controls the operations of the scanning signal line driver YDR and video signal line driver XDR. The controller 3 receives a digital video signal, a sync signal, a glasses operation determination signal and a 3D determination signal, which are supplied from the outside. The controller 3 generates, based on the sync signal, a vertical scan control signal which controls a vertical scan timing, and a horizontal scan control signal which controls a horizontal scan timing, and supplies the vertical scan control signal and horizontal scan control signal to the scanning signal line driver YDR and video signal line driver XDR. The controller 3 supplies the digital video signal to the video signal line driver XDR in sync with the horizontal and vertical scan timings.

The video signal line driver XDR converts, in each horizontal scanning period, the digital video signal to an analog-format signal under the control of the horizontal scan control signal, and supplies resultant video signals Vsig to the plural video signal lines SG1 to SGN in parallel. The scanning signal driver YDR outputs scanning signals to the scanning signal lines GL1a to GLMa, GL1b to GLMb, and GL1c to GLMc under the control of the vertical scan control signal. The scanning signal lines GL1a to GLMa and GL1b to GLMb are select scanning lines for selecting pixel circuits on a row-by-row basis. The scanning signal lines GL1c to GLMc are light-control scanning lines for controlling emission periods of organic EL elements.

The controller 3, video signal line driver XDR and scanning signal line driver YDR in the second embodiment correspond to the control circuit 10 in the first embodiment.

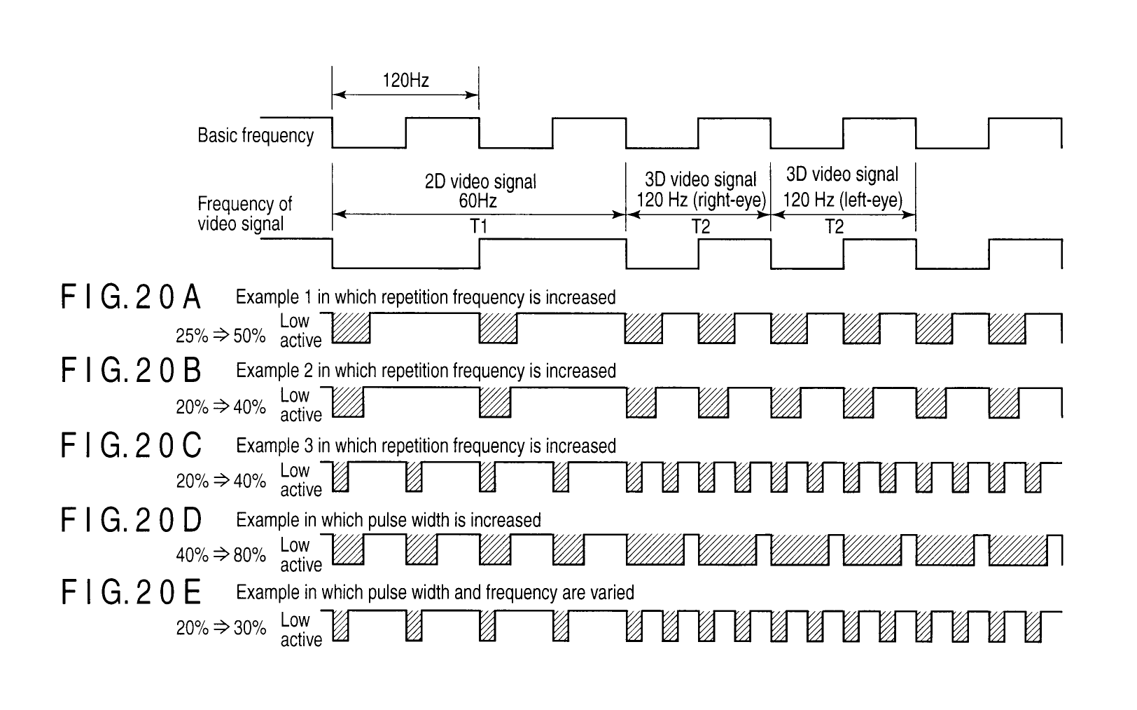

FIG. 20A to FIG. 20E are exemplary diagrams for explaining methods of controlling the luminance in cases of displaying a video signal of a 2D image corresponding to a first operational frequency (60 Hz) and a video signal of a 3D image corresponding to a second operational frequency (120 Hz). In FIG. 20A to FIG. 20E, hatched rectangular parts indicate emission periods in which the organic EL elements OLED emit light. Specifically, the emission period is a period in which the switch SW3 of each pixel circuit CT is turned “ON” by the scanning signal which is output from the scanning signal line driver YDR via the scanning signal lines GL1c to GLMc.

FIG. 20A shows Example 1 in which the time interval of the scanning signal, which is output for light emission, is decreased. When a 2D image is displayed, two emission periods are provided in a display period (T1) of 60 Hz. On the other hand, when a 3D image is displayed, two emission periods are provided in a display period (T1) of 120 Hz. In order to equalize the total luminance in the respective display periods, the interval of emission start is varied, with a single emission time being the same. As a result, the duty ratio is 25% in the display of the 2D image, while the duty ratio is 50% in the display of the 3D image.

FIG. 20B shows Example 2 in which the time interval of the scanning signal, which is output for light emission, is decreased. Example 2 differs from Example 1 in that the duty ratio in the display of the 2D image is 20%, while the duty ratio in the display of the 3D image is 40%. However, the luminance control method in Example 2 is the same as that in Example 1 shown in FIG. 20A.

FIG. 20C shows Example 3 in which the time interval of the scanning signal, which is output for light emission, is decreased. In Example 3, the duty ratio in the display of the 2D image is 20%, while the duty ratio in the display of the 3D image is 40%. This control of the duty ratio is the same as in Example 2. The method of the luminance control is the same as in Example 2 shown in FIG. 20B. However, Example 3 differs from Example 2 in that four emission periods, in each of which the light emission time is decreased, are provided.

FIG. 20D shows an example in which the light emission time of the scanning signal, which is output for light emission, is increased. In the display of the 2D image, four emission periods are provided and the duty ratio is set at 40%. In the display of the 3D image, two emission periods are provided, the light emission time in each emission period is doubled, and the duty ratio is set at 80%.

FIG. 20E shows an example in which the light emission time and the interval of emission start of the scanning signal, which is output from for light emission, are varied. In the display of the 2D image, four emission periods are provided and the duty ratio is set at 20%. In the display of the 3D image, four emission periods are provided, the light emission time in each emission period is decreased, and the duty ratio is set at 30%.

As has been described above, in the second embodiment, the number of emission periods and the light emission time in the display period are controlled, and thereby a desired duty ratio is realized. The control of the number of emission periods and the light emission time can be realized by the cooperation between the controller 3 and the scanning signal line driver YDR.

In the second embodiment, the voltage write method is adopted in the pixel circuit CT. Alternatively, the current write method may be adopted in the pixel circuit CT. The structural elements of the organic EL display device disclosed in the first embodiment and the structural elements of the organic EL display device disclosed in the second embodiment may be combined, as needed.

According to the above-described embodiments, the switching of the luminance of the organic EL element OLED can be realized by a simpler structure, compared to the switching of the luminance of a liquid crystal display panel. Specifically, in the case of the liquid crystal display panel, it is necessary to establish synchronism with the backlight which illuminates the liquid crystal display panel, while considering the response speed of liquid crystal molecules and applying a driving method (e.g. black insertion driving) matching with the characteristics of the liquid crystal molecules. On the other hand, since the organic EL element OLED is self-luminous, an illumination unit, such as a backlight, is needless, and thus the synchronism with the illumination unit is needless. Moreover, the luminance of the organic EL element OLED can easily be adjusted by the duty ratio of the organic EL element OLED or the video signal (driving current or driving voltage) which is written in the pixel circuit CT.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An organic EL display device comprising:
an organic EL element;
a pixel circuit configured to include an output switch which controls emission/non-emission of the organic EL element; and
a luminance switching module configured to output to the output switch a first control signal which causes the organic EL element to emit light with a first total emission time per unit time, when a first display mode of displaying a two-dimensional image is selected, and to output to the output switch a second control signal which causes the organic EL element to emit light with a second total emission time, which is longer than the first total emission time, per unit time, when a second display mode of displaying a three-dimensional image is selected.

2. The organic EL display device of claim 1, wherein the two-dimensional image is displayed with a first operational frequency in the first display mode, and the three-dimensional image is displayed with a second operational frequency, which is double the first operational frequency, in the second display mode.

3. The organic EL display device of claim 1, wherein the luminance switching module is configured to set a third maximum luminance which is higher than a first maximum luminance in the first display mode and is lower than a second maximum luminance in the second display mode, immediately after the first display mode is switched to the second display mode.

4. The organic EL display device of claim 1, further comprising:
a mode select module configured to select one of the first display mode and the second display mode; and
glasses configured to include optical shutters on a right eye side and a left eye side and to output to the mode select module a glasses operation determination signal for determining that the shutters have operated.

5. The organic EL display device of claim 1, wherein each of the first control signal and the second control signal includes at least one basic control signal for causing the organic EL element to emit light once for a predetermined time, and
the number of the basic control signals included in the unit time of the second control signal is greater than the number of the basic control signals included in the unit time of the first control signal.

6. The organic EL display device of claim 1, wherein each of the first control signal and the second control signal includes the same number of basic control signals each for causing the organic EL element to emit light once, and
an emission time of the organic EL element by one basic control signal included in the second control signal is longer than an emission time of the organic EL element by one basic control signal included in the first control signal.

7. The organic EL display device of claim 1, wherein each of the first control signal and the second control signal includes at least one basic control signal for causing the organic EL element to emit light once, and
the number of the basic control signals included in the unit time of the first control signal is different from the number of the basic control signals included in the unit time of the second control signal, and an emission time of the organic EL element by one basic control signal included in the first control signal is different from an emission time of the organic EL element by one basic control signal included in the second control signal.

8. The organic EL display device of claim 1, further comprising a mode select module configured to output to the luminance switching module a select signal indicating which of the first display mode and the second display mode is to be selected,
wherein the luminance switching module is configured to output, when the select signal which mutually switch the first display mode and the second display mode is input, the first control signal and the second control signal by mutually switching the first control signal and the second control signal, after passing of a predetermined time from the input of the select signal.

9. An organic EL display device comprising:
an organic EL element;
a pixel circuit configured to include a driving transistor which controls driving of the organic EL element; and
a luminance switching module configured to output to the driving transistor a first video signal which causes the organic EL element to emit light with a first luminance when a first display mode of displaying a two-dimensional image is selected, and to output to the driving transistor a second video signal which causes the organic EL element to emit light with a second luminance, which is higher than the first luminance, when a second display mode of displaying a three-dimensional image is selected.

10. The organic EL display device of claim 9, wherein the two-dimensional image is displayed with a first operational frequency in the first display mode, and the three-dimensional image is displayed with a second operational frequency, which is double the first operational frequency, in the second display mode.

11. The organic EL display device of claim 9, wherein the luminance switching module is configured to set a third maximum luminance which is higher than a first maximum luminance in the first display mode and is lower than a second maximum luminance in the second display mode, immediately after the first display mode is switched to the second display mode.

12. The organic EL display device of claim 9, further comprising:
a mode select module configured to select one of the first display mode and the second display mode; and
glasses configured to include optical shutters on a right eye side and a left eye side and to output to the mode select module a glasses operation determination signal for determining that the shutters have operated.

13. The organic EL display device of claim 9, wherein the luminance switching module includes a signal conversion module configured to convert video data, which is supplied from outside, to an analog video signal which is output to the pixel circuit, and
the signal conversion module is configured to execute conversion with respect to video data having the same gradation in a manner that an absolute value of the second video signal, which is converted in the second display mode, is made greater than an absolute value of the first video signal which is converted in the first display mode.

14. The organic EL display device of claim 9, wherein the luminance switching module includes a signal conversion module configured to convert video data, which is supplied from outside, to an analog video signal which is output to the pixel circuit, and
the signal conversion module is configured to execute conversion such that a dynamic range after conversion in the second display mode is made larger than a dynamic range after conversion in the first display mode, and executes conversion with respect to video data having the same gradation in a manner that an absolute value of the second video signal, which is converted in the second display mode, is made greater than an absolute value of the first video signal which is converted in the first display mode.

15. The organic EL display device of claim 9, further comprising a mode select module configured to output to the luminance switching module a select signal indicating which of the first display mode and the second display mode is to be selected,
wherein the luminance switching module is configured to output, when the select signal which mutually switch the first display mode and the second display mode is input, the first control signal and the second control signal by mutually switching the first control signal and the second control signal, after passing of a predetermined time from the input of the select signal.

16. An organic EL display device comprising:
a plurality of pixel units arranged in a matrix on a substrate;
a signal line provided in association with each of columns, connected to the associated pixel units of the associated column, and configured to supply a signal corresponding to a video signal to the associated pixel units;
a select scanning line provided in association with each of rows, connected to the associated pixel units of the associated row, and configured to supply to the associated pixel units a signal which selects the pixel units in units of a row corresponding to the video signal;
a light-control scanning line provided in association with each of the rows, connected to the pixel units of the same emission light color of the associated row, and configured to supply a control signal which controls an emission period of organic EL elements of the pixel units in units of a selected row; and
a luminance switching module configured to output to the light-control scanning line a first control signal which causes the organic EL elements to emit light with a first total emission time per unit time, when a first display mode of displaying a two-dimensional image is selected, and to output to the light-control scanning line a second control signal which causes the organic EL elements to emit light with a second total emission time, which is longer than the first total emission time, per unit time, when a second display mode of displaying a three-dimensional image is selected.

17. The organic EL display device of claim 16, wherein the two-dimensional image is displayed with a first operational frequency in the first display mode, and the three-dimensional image is displayed with a second operational frequency, which is double the first operational frequency, in the second display mode.

18. An organic EL display device comprising:
a plurality of pixel units arranged in a matrix on a substrate;
a signal line provided in association with each of columns, connected to the associated pixel units of the associated column, and configured to supply a signal corresponding to a video signal to the associated pixel units;
a select scanning line provided in association with each of rows, connected to the associated pixel units of the associated row, and configured to supply to the associated pixel units a signal which selects the pixel units in units of a row corresponding to the video signal;
a light-control scanning line provided in association with each of the rows, connected to the pixel units of the same emission light color of the associated row, and configured to supply a control signal which controls an emission period of organic EL elements of the pixel units in units of a selected row; and
a luminance switching module configured to output to the signal line a first video signal which causes the organic EL elements to emit light with a first luminance when a first display mode of displaying a two-dimensional image is selected, and to output to the signal line a second video signal which causes the organic EL elements to emit light with a second luminance, which is higher than the first luminance, when a second display mode of displaying a three-dimensional image is selected.

19. The organic EL display device of claim 18, wherein the two-dimensional image is displayed with a first operational frequency in the first display mode, and the three-dimensional image is displayed with a second operational frequency, which is double the first operational frequency, in the second display mode.

20. A display method of an organic EL display device, the organic EL display device including an organic EL element, a pixel circuit configured to include an output switch which controls emission/non-emission of the organic EL element, and a luminance switching module configured to output to the output switch a control signal which causes the organic EL element to emit light, the display method comprising:
outputting to the output switch a first control signal which causes the organic EL element to emit light with a first total emission time per unit time, when a first display mode of displaying a two-dimensional image is selected; and
outputting to the output switch a second control signal which causes the organic EL element to emit light with a second total emission time, which is longer than the first total emission time, per unit time, when a second display mode of displaying a three-dimensional image is selected.
